(19) United States
(12) Patent Application Publication
(10) Pub. No.: US 2016/0267787 A1
(43) Pub. Date: Sep. 15, 2016

(54) SYSTEMS AND METHODS FOR WIRELESS OPERATION OF ACCESSIBLE PEDESTRIAN SIGNAL (APS) SYSTEMS

(71) Applicant: POLARA ENGINEERING, INC., Corona, CA (US)

(72) Inventors: Brad P. Whitney, Lafayette, LA (US); Craig B. Stein, Coto De Caza, CA (US); Ryan P. Macias, Corona, CA (US)

(21) Appl. No.: 14/862,152

(22) Filed: Sep. 22, 2015

Related U.S. Application Data
(60) Provisional application No. 62/053,381, filed on Sep. 22, 2014.

(51) Int. Cl. G08G 1/005; G08B 6/00; G08B 3/10

(52) U.S. Cl. CPC G08G 1/005; G08B 3/1016; G08B 6/00; H04W 84/12

(57) ABSTRACT

An APS wireless network that wirelessly connects multiple APS systems with pedestrians and authorized traffic or transportation personnel via wireless enabled peripheral devices.

### CROSS-REFERENCE TO RELATED APPLICATIONS

This application claims the benefit of U.S. Provisional Application No. 62/053,437, filed Sep. 22, 2014, which application is incorporated herein by reference.

### FIELD

The embodiments described herein generally relate to Accessible Pedestrian Signal (APS) systems, more particularly, to systems and methods that facilitate wireless interconnect, control and operation of APS systems and central controllers.

### BACKGROUND

Most metropolitan areas in the United States and elsewhere have intersections controlled by traffic lights. These intersections are also equipped with Walk/Don't Walk signals to make it safe for pedestrians to cross the street. Such Walk/Don't Walk signals are invariably equipped to provide a visual Walk/Don't Walk signal. For the visually impaired persons such as persons of limited or no vision, such lighted signals are often of no value. For this reason various pedestrian signal systems, commonly referred to as applied pedestrian signal (APS) systems, have been developed which provide an audible or tactile signal that persons of impaired vision can use. Examples of such APS systems are described in U.S. Pat. Nos. 7,253,720, 7,145,476, 6,982,630 and 6,340,936, which patents are incorporated herein by reference.

Current industry practice is to typically use physical wired computer connections like USB or an infrared or ‘line of sight’ communication device to connect to the APS systems to enable authorized traffic and transportation personnel to configure, program, interoperate, etc., the APS systems. To use such connection methods requires opening the traffic cabinet and dissembling portions of the APS systems. It also requires a separate computer, or personal computing device and cables that are not often easily transportable or accessible. The activities typically conducted by such personnel when connected to the APS systems tend to include setting and reading settings or configuration information including volume levels, extended push minimum time, sounds to play upon certain events, etc., retrieving operational information such as the quantity of pedestrian switch activations, the quantity of extended push activations, internal system logs, etc., installing, downloading, or updating audio messages, and loading or upgrading firmware. These activities are all related to installation or service technicians activities, and do not include the pedestrian.

Accordingly, it is desirable to provide systems and methods that facilitate wireless operation of APS systems to provide enhanced pedestrian features, better vehicular traffic flow, and simplify installation and service.

### SUMMARY

The embodiments described herein are directed to systems and methods that facilitate wireless operation of APS systems to provide enhanced pedestrian features, better vehicular traffic flow, and simplify installation and service. In certain embodiments, a wireless network connects multiple APS systems with pedestrians and authorized traffic or transportation personnel. Communication with APS systems by pedestrians and authorized personnel is preferably conducted using a wireless technology standard for exchanging data over short distances such as, e.g., Bluetooth (Low Energy and Classic). Communication with a central control unit by authorized personnel is preferably conducted over a different wireless technology such as, e.g., Wireless LAN (WIFI). Communication between the central control unit and the APS systems is preferably conducted via wired power line communication (PLC). The wireless network enables communication from mobile devices, wearable devices, portable computers and any other Bluetooth or WIFI enabled peripherals. The APS systems and the central control unit can be customized and configured to transportation or traffic department preferences as well as specialized pedestrian interfaces and messaging. Preferences like volume, tone, language, message content, timing, and other custom features can be programed through the Bluetooth or WIFI interface. Software and firmware customizations and upgrades can also be programed wirelessly through the wireless interfaces. In addition, diagnostic features displaying system health and status can be displayed through the intelligent wireless interfaces.

Other systems, methods, features and advantages of the example embodiments will be or will become apparent to one with skill in the art upon examination of the following figures and detailed description.

### BRIEF DESCRIPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a wireless enabled APS intersection having four (4) crosswalks and eight (8) wireless enabled APS systems, i.e., two (2) APS systems per crosswalk with one APS at each end of the crosswalk.

FIG. 2 is a schematic of the wireless enabled APS intersection shown in FIG. 1 and illustrating a single wireless connection between a wireless enabled peripheral device and an APS system to setup multiple APS systems in the intersection.

FIG. 3 is a schematic of the wireless enabled APS intersection shown in FIG. 1 and illustrating a single wireless connection between a wireless enabled peripheral device and an APS system to setup other APS systems in the intersection by communicating with specified APS systems and pass custom messages to the specified APS systems.

FIG. 4 is a schematic of the wireless enabled APS intersection shown in FIG. 1 and illustrating a pedestrian receiving notifications on his or her wireless enabled peripheral device for notifications, alerts, audio messages, or RSSI use for unique identification and message exchange.

FIG. 5 is a schematic of the wireless enabled APS intersection shown in FIG. 4 and illustrating the pedestrian's wireless enabled peripheral device being identified by two APS systems to gather rate of travel and proximity within the crosswalk data.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to systems and methods that facilitate wireless operation of APS systems. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The embodiments described herein are directed to systems and methods that facilitate wireless operation of APS systems to provide enhanced pedestrian features, better vehicular traffic flow, and simplify installation and service. In certain embodiments, a wireless network connects multiple APS systems with pedestrians and authorized traffic or transportation personnel via wireless technologies such as, e.g., Bluetooth (Low Energy and Classic) and Wireless LAN (WIFI) technology. The wireless network enables communication from mobile devices, wearable devices, portable computers and any other Bluetooth or WIFI enabled peripherals to interoperate with and control APS and central control systems. The network and APS systems are configured to enable full APS intersection control through wireless, such as Bluetooth and WIFI, and wired interoperability.

WIFI interoperates with the central controller and enables full access to the APS systems and, thus, control of the APS intersection and all the collaborative features governed by wireless interoperability such as Bluetooth interoperability. Once a WIFI link is established with the central controller, the WIFI enabled user device has access to all the APS systems at the intersection. The WIFI connected user can update all APS systems in the same way the user updates an individual APS system via Bluetooth.

Wireless technologies such as Bluetooth and WIFI interoperate with all aspects of audio control, firmware enhancements, or upgrades, parameter tuning, capability advertising, status, health, configurability, customizing, and expanding features, and enable full retrofit or brand new system installations, and maintenance to intersections containing any quantity of APS systems.

Wireless message passing enables pedestrian peripheral devices to exchange with the APS system detailed communications and instructions based on customized alerts, notifications, and preferences. This two way communication allows for pedestrian requests to be communicated as well as the APS system transmitting key information such as, e.g., volume, volume ratio to ambient, sound played internally or externally, mute, tone choice, language selection, phase assignment, walk and don't walk audio, or vibrate type, emergency tones or audio. Pedestrian requests may include placing a pedestrian call as soon as they are with wireless (such as Bluetooth) transmission range so it emulates a button push without physical contact, special messages to accompany a special need, reduce sound of other APS systems while closest APS is playing, broadcast the sound on overhead speakers, special synchronization of APS systems at the intersection for special events. A central traffic office can view the full intersection via an Ethernet connection to the central control unit that accesses all the APS systems.

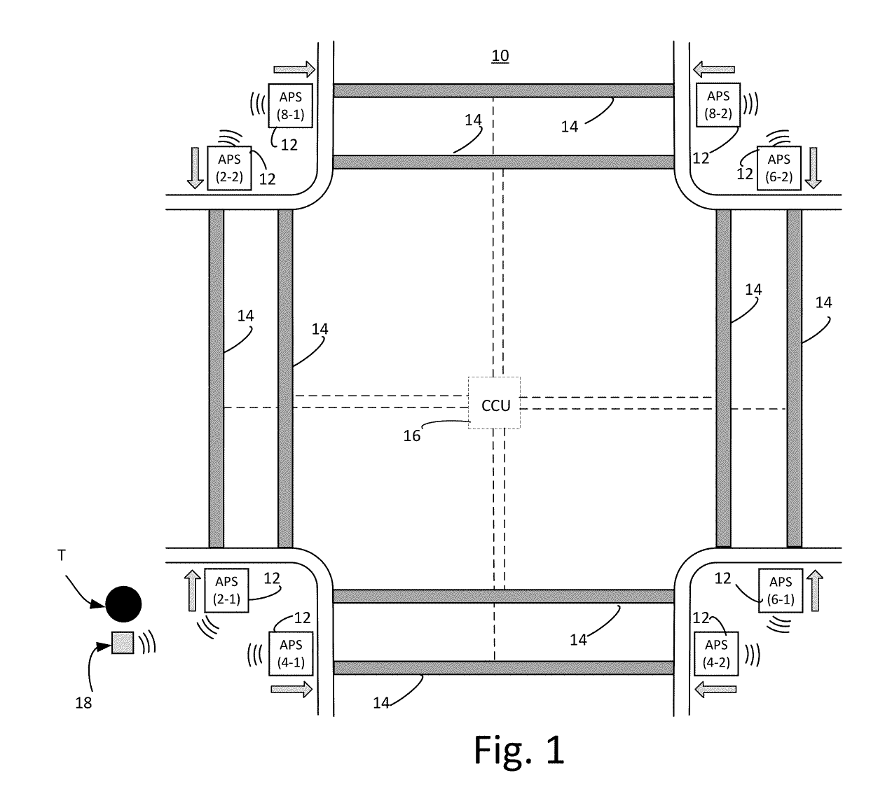

Turning to the figures, FIG. 1 shows a wireless enabled APS intersection 10 having four (4) crosswalks and eight (8) wireless enabled APS systems 12, i.e., two (2) APS systems 12 per crosswalk with one APS system 12 at each end of the crosswalk. The APS intersection 10 further comprises a central control unit (CCU) 16 and a plurality of power line communication (PLC) wires 14 forming a PLC network interconnecting the APS systems 12 and the CCU 16. An authorized traffic or transportation personnel T with a wireless enabled, such as Bluetooth and WIFI enabled, peripheral device 18 is show in close proximity to one of the APS systems 12 [APS (2-1)].

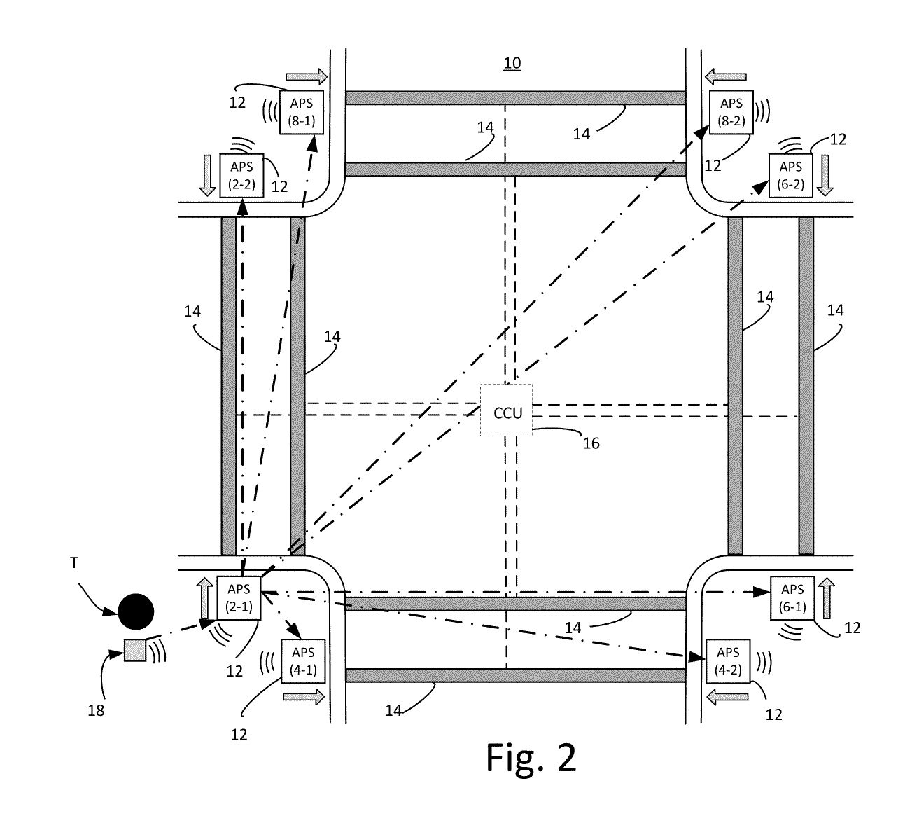

As depicted in FIG. 2, a single wireless connection between the peripheral device 18 of the technician T and one of the APS systems 12 [APS (2-1)] is shown and used to setup multiple APS systems 12 in the APS intersection 10. The peripheral device 18 connects to the APS systems 12 [APS (2-1)] similar to a wireless access point that gives the peripheral device 18 access to the CCU 16 to update the other APS systems 12 [APSs (2-2; 4-1; 4-2; 6-1; 6-2; 8-1; 8-2)] via PLC wired communication over the PLC wires 14. The communication traffic gets routed from the peripheral device 18 to the single APS system 12 [APS (2-1)] then through the central controller 16 to update all or some of the other APS systems 12 [APSs (2-2; 4-1; 4-2; 6-1; 6-2; 8-1; 8-2)] over the PLC wires 14.

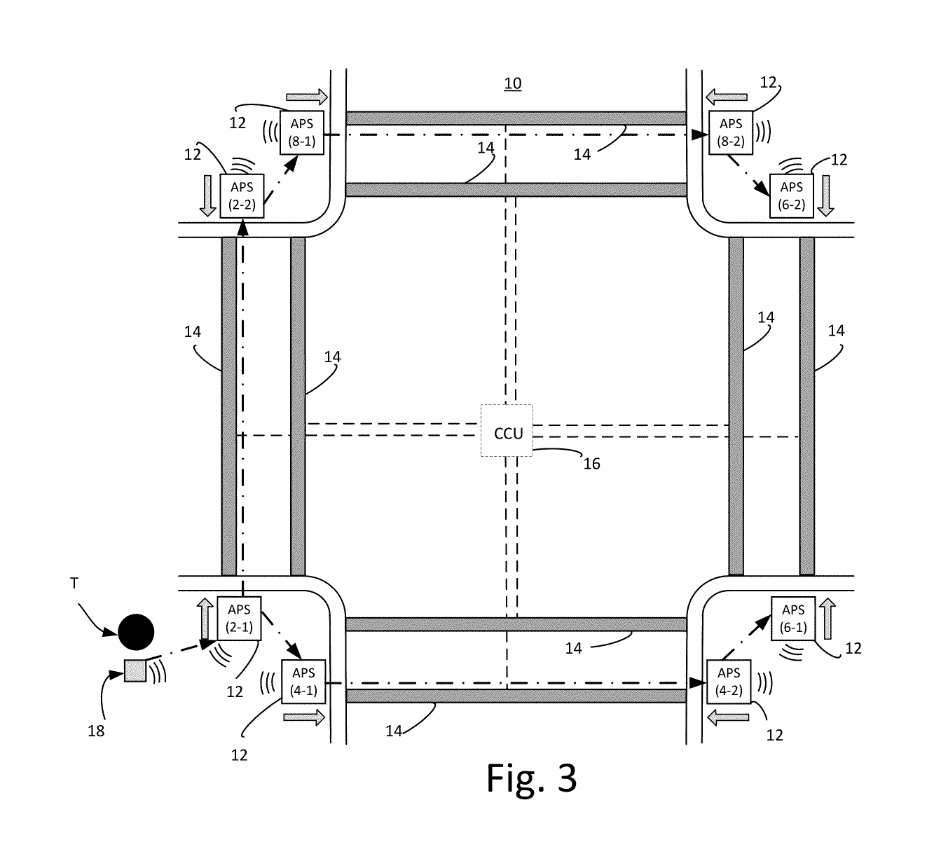

Turning to FIG. 3, a similar interaction between the APS systems 12 to that illustrated in FIG. 2 is shown. As depicted, a single wireless connection between the peripheral device 18 of the technician T and a single APS system 12 [APS (2-1)] is shown and used to setup other APS systems 12 in the APS intersection 10. In this case, the single APS system 12 [APS (2-1)] can communicate with specified APS systems 12, e.g., APS (2-2), APS (4-1), APS (4-2), APS (6-1), APS (6-2), APS (8-1) and/or APS (8-2), and pass custom messages to certain ones of the APS systems 12.

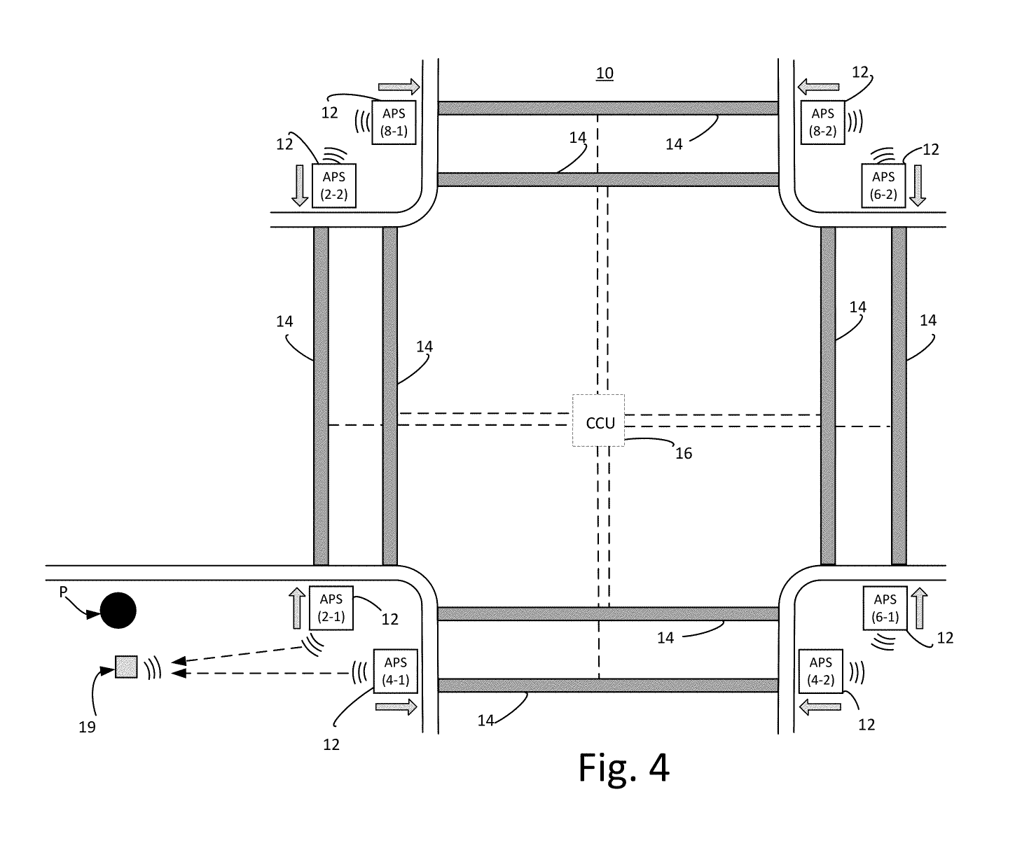

Referring to FIG. 4, a pedestrian P with a wireless enabled, such as Bluetooth and WIFI enabled, peripheral device 19 is shown in close proximity to two of the APS systems 12 [APS (2-1) and (4-1)]. As depicted, the peripheral device 19 of the pedestrian P is shown receiving notifications, alerts, audio messages, or RSSI use for unique identification and message exchange from the two systems 12 [APS (2-1) and (4-1)].

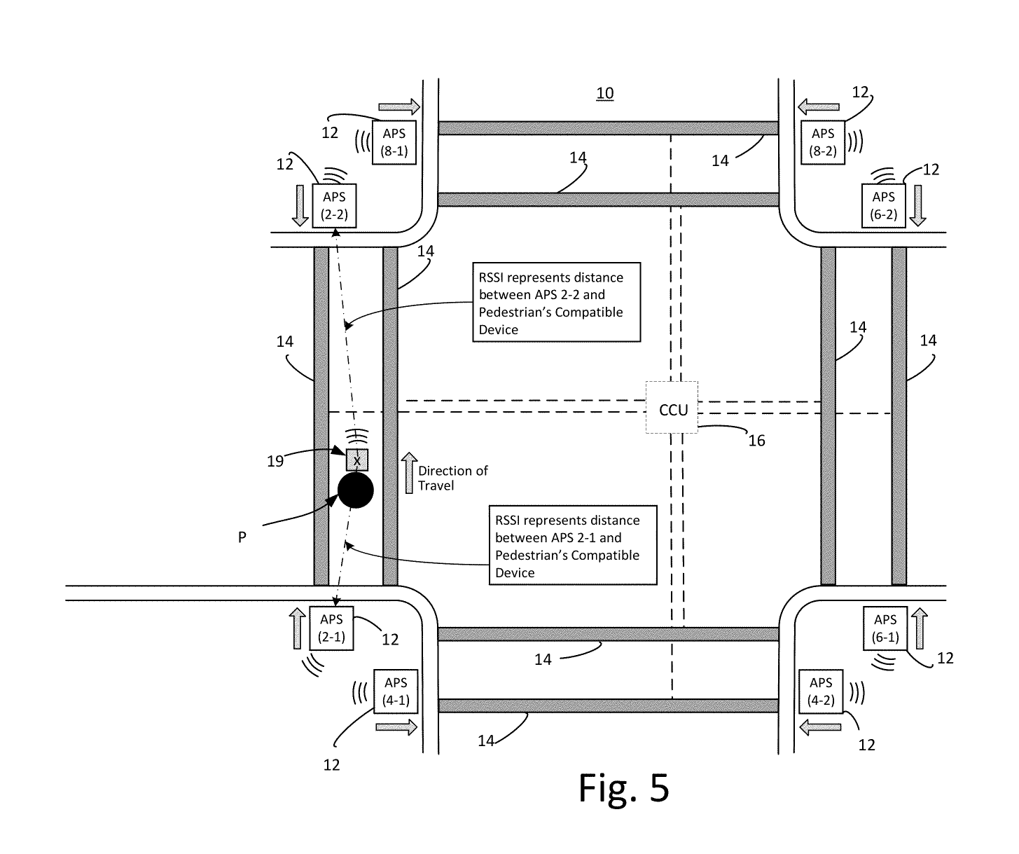

Turning to FIG. 5, a pedestrian P is shown in a cross walk with his or her peripheral device 19 being identified by two of the APS systems 12 [APS (2-1) and (2-2)] at opposite ends of the cross walk to gather rate of travel and proximity within the crosswalk data. As depicted, the RSSI represents distance between the APS systems 12 [APS (2-1) and (2-2)] and the peripheral device 19 of the pedestrian P.

In certain embodiments, a network of APS systems is wirelessly accessible by any wireless enabled peripheral device utilizing wireless technologies such as Bluetooth or WIFI and, thus, the APS systems within the network can be wirelessly controlled and customized along with the central controller software and firmware enabled features including, but not limited to audio programmability, system timing, calendar, foreign language, special traffic or transportation messages or standards, and system upgrades, status, and health.

In certain other embodiments, communication between APS systems is accomplished via a combination of wireless and wired messaging through a single connection between a wireless peripheral device and an APS System to multicast to multiple APS systems in the network, or a single connection between a wireless peripheral device and an APS System to broadcast to all other APS systems in the network.

In certain other embodiments, an APS system may exchange information with a peripheral device to assist a visually impaired pedestrians in locating a necessary APS system on a street or intersection. The visually impaired pedestrian's wireless enabled peripheral device can use the Received Signal Strength Indicator (RSSI) to help identify location. The signal strength provides a good estimate of the transmitting device's distance from the receiver. The RSSI can be used in this manner to estimate pedestrian proximity and increase or decrease an APS system's audio and/or vibration intensity as needed. In certain other embodiments, the APS system sends information messages to a pedestrian's wireless enabled peripheral device, alerting him or her of when to walk, and don't walk. Additionally, special messages related geographical proximity can be passed to further assist.

In certain other embodiments, the APS system sends information messages to a pedestrian's wireless enabled peripheral device informing him or her of the time to next walk interval

In certain other embodiments, the APS system sends information messages to a pedestrian's wireless enabled peripheral device, alerting him or her of critical or emergency information.

In certain other embodiments, the APS system sends information messages to a pedestrian's wireless enabled peripheral device, alerting him or her of cars approaching intersection at unsafe speed while walk interval is on. This information may also be transmitted to a central traffic office.

In certain other embodiments, the APS system data and statistics are exchanged and recorded to monitor important traffic and transportation parameters used to drive predictive metrics for improved traffic planning and pedestrian safety. Metrics like, average time for pedestrians to cross the intersection can be used to adjust pedestrian interval timing to improve overall traffic, or pedestrian flow. Pedestrians can also be alerted via their mobile devices of the typical walk interval cycle time for planning the walking or cycling routes.

In certain other embodiments, the pedestrian's or bicyclist's wireless enabled peripheral device sends a message to the APS initiating a button push as they approach without physically touching the APS device.

In certain other embodiments, the APS systems track pedestrian or bicyclist's pace and adherence to the crosswalk via a timer and RSSI to identify abnormalities that create safety concerns. Audio messages and vibration frequencies can be used on both the APS and pedestrian peripheral devices to create alerts.

In certain other embodiments, the APS system and wireless enabled peripheral device messages are used to identify visually impaired and other unique pedestrians, and interoperate based on unique device identifiers or electronic certificates. For example, a visually impaired pedestrian may have an application on his or her mobile device with an electronic signature similar to the way a handicap sticker is displayed today. The APS system recognizes that signature once the wireless connection is made. Once the unique electronic signature is identified, the APS and pedestrian applications can exchange special communication messages and operate accordingly.

In certain other embodiments, central traffic control offices governed by cities or transportation departments may be allowed to monitor complete intersections over Ethernet connections via the wireless system infrastructure and Simple Network Messaging Protocol (SNMP) messages via the wireless system.

In operation, an APS system could connect to a pedestrian's wireless peripheral device, such as a Smartphone, then the pedestrian could operate specific features such as audible message volume levels, language used, safety information (e.g. caution: vehicle waiting to make a right turn), path guidance to destination (e.g. use this APS to cross to your grocery store), etc. BTLE/BT is used to link to the pedestrian's Smartphone with each APS that the pedestrian ventures near. If the Smartphone has the APP, then that APS (without using a central control or monitory unit) would pole the Smartphone for customized settings and use those settings while the Smartphone was within range. The APSs would preferably include an API on top of the BTLE/BT which retrieves external settings, and arbitrates conflicting settings.

Conventionally, APSs have been viewed and used as “set and forget” units, and as single users. The embodiments described herein permit the APSs to be adjusted for each and every user, either alone or as a group.

The embodiments described herein further enable installation or service technicians to access all APS's on the network (local or city wide) from any location without physically gaining access to the equipment or associated hardware, enable installation or service technicians to engage in direct verbal communication with a person on a Smartphone through the APS, and enable crisis or emergency responders to send warning messages from their Smartphone which are sent to the APS's directing pedestrians away from danger (e.g. tsunami warning, move to high ground).

The embodiments provided herein further include a method of internal representation and algorithm are used to convert the raw data into meaningful SNMP messages. APSs could sense the number of pedestrians via Smartphones and send to traffic management the approximate group size and directions of travel which would permit more efficient traffic flow by managing the pedestrian cycles. Without use of GPS features (because the locations of the APS's are already known) via BTLE/BT the APSs are aware of each BTLE/BT device within range. An APS network Central Control Unit (CCU) would periodically receive this information from each connected APS, and then develop an internal representation of location of each unit, its direction of travel, and speed. Special SNMP messages are then sent to the traffic center with this information. For decades the traffic industry has focused on detection with passive methods (inductive, camera, physical buttons, etc. and a “contact closure”) to identify pedestrians. The embodiments provided herein create meaningful SNMP messages providing more information related to number of persons, directions of travel, and speed.

The APSs can be used for other communications. For example, pedestrians may receive on their Smartphones via the APSs special offers from nearby businesses.

During installation and service, Smartphones are almost always with installation or service technicians, so with the proper application they are able to program, change messages/sounds, change settings, without needing special cables, etc., as currently required.

APS to APS, or other APS related devices, communication can be used to permit new equipment functions/features (e.g. a separately powered external speaker playing audible messages).

The embodiments provided herein further include a peer-peer network for False Walk Indication detection with an RTOS thread for monitoring and system hard-boot. A critical issue with APSs is the detection and prevention of a “False Walk Indication”. When two or more APSs are positioned within signal range of each other, an APS resident peer-peer monitoring program is used to detect either another APS, or self-monitoring, with a False Walk Indication. Implementation requires an API on top of existing BTLE/BT protocols for intercommunication, and a real-time-operating-system (RTOS) thread for program monitoring. When a False Walk Indication event occurs, the offending APS program thread would force the APS to perform a hard re-boot. With conventional APSs, the monitoring for faults has been internal only to the specific APS, or a central control/monitor. There has been no peer-peer communication for redundancy.

Although the present invention has been described and illustrated in the foregoing exemplary embodiments, it is understood that the present disclosure has been made only by way of example, and that numerous changes in the details of implementation of the invention may be made without departing from the spirit and scope of the invention. Features of the disclosed embodiments can be combined and rearranged in various ways.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A wireless enabled APS system network comprising
a plurality of APS systems, wherein individual ones of the plurality of APS systems are accessible via wireless enabled peripheral devices,
a central control unit, and
a plurality of power line communication wires interconnecting the plurality of APS systems and the central control unit.

2. The wireless enable APS system of claim 1, where the APS systems are Bluetooth or WIFI enabled.

3. The wireless enabled APS system of claim 1, wherein communication between APS systems is via a combination of wireless and wired messaging through one of single connection to multicast and single connection to broadcast.

4. The wireless system of claim 1, wherein the APS systems are configured to exchange information with the wireless enabled peripheral devices to assist in locating APS systems in network.

5. The wireless system of claim 4, wherein the APS systems are configured to send information messages to the wireless enabled peripheral devices instructing whether to walk.

6. The wireless system of claim 4, wherein the APS systems are configured to send information messages to the wireless enabled peripheral devices instructing as to the time to next walk interval.

7. The wireless system of claim 4, wherein the APS systems are configured to send information messages to the wireless enabled peripheral devices alerting as to critical or emergency information.

8. The wireless system of claim 4, wherein the systems are configured to send information messages to the wireless enabled peripheral devices alerting as to cars approaching intersection at unsafe speed while walk interval is on.

9. The wireless system of claims 1 and 4, wherein the wireless enabled peripheral devices send a message to the individual APS systems initiating a touchless button push.

10. The wireless system of claim 1, wherein APS systems are configured to track pedestrian or bicyclist's pace and adherence to the crosswalk via a timer and RSSI.

12. The wireless system of claim 1, wherein APS systems and the wireless enabled peripheral devices messages are used to identify visually impaired and other unique pedestrians, and interoperate based on unique device identifiers or electronic certificates.
